(19) United States
(12) Patent Application Publication
(10) Pub. No.: US 2025/0128494 A1
(43) Pub. Date: Apr. 24, 2025

(54) TRACTION BOARD

(71) Applicant: Bedford Industries, Worthington, MN (US)

(72) Inventor: Jay Alan Milbrandt, Worthington, MN (US)

(21) Appl. No.: 18/921,782

(22) Filed: Oct. 21, 2024

Related U.S. Application Data
(60) Provisional application No. 63/592,042, filed on Oct. 20, 2023.

(51) Int. Cl. B32B 3/30; B29C 70/78; B29K 105/26; B32B 27/08

(52) U.S. Cl. CPC B32B 3/30; B29C 70/78; B32B 27/08; B29K 2105/26; B32B 2307/744; B32B 2607/00

(57) ABSTRACT

A composite traction member comprising a polymer traction layer configured to promote traction and including a layer interface, a polymer structural substrate molded to the polymer traction layer including a substrate face coupled along the layer interface and a molded weld assembly interconnecting the polymer structural substrate and the polymer traction layer, and a method of manufacturing the composite traction member.

### CLAIM FOR PRIORITY

This application claims the benefit of priority of U.S. Application Ser. No. 63/592,042, filed Oct. 20, 2023, which is hereby incorporated by reference in its entirety.

### TECHNICAL FIELD

This document pertains generally, but not by way of limitation, to structural members, such as boards, planks, panels or the like that simulate lumber or the like with a traction layer and both the structural member and the traction layer are formed from polymer materials.

### BACKGROUND

Outdoor structures, furniture or the like are formed with lumber. For example, decks, patios, walkways, ramps, or the like are constructed from lumber planks, boards, panels or the like. In some examples, a tractional surface having grit, knurling or the like is adhered, bolted, fastened (nailed, screwed, or bolted) to surfaces of the lumber to form a non-slip style surface. Tractional surfaces, or non-slip surfaces, facilitate traction in wet or damp environments (docks, pool surfaces, ski hills, snow sport areas) where slipping or falling is more prevalent. Lumber used in wet environments is exposed to environments that increase the likelihood of decay, decomposition or other damage to the lumber, the tractional surface or both.

In some examples, polymer boards (sometimes called poly-lumber) are replacements for traditional wood lumber. Polymer boards are, in some examples, water resistant. Because of the water-resistant quality of polymer boards, they have, in some examples, characteristics that aid in minimizing decomposition. In some examples polymer boards include tractional surfaces. In these examples, the polymer boards have a tractional surface adhered, coupled, or fastened (nailed, screwed, or bolted) to a surface of a polymer board.

Traction layers, in some examples, are adhered to a surface of a polymer board by gluing, laminating, pressing or the like. For example, a film is joined with a solid material such as a plastic, or other polymer, board with an adhesive material, such as glue. The film, in another example, is laminated on the surface of the solid plastic board. In an example, the laminated film is joined to the plastic, solid board with application of hot pressing. Hot pressing involves, for example, laminating a film on top of a second, solid, structural material, such as a board, and a press applies heat to the laminated film. In such an example, the combination of pressure and heat initiates adhesion between the film and the second, solid, structural material. In another example, a traction layer is adhered to a solid board with fasteners, such as nails, screws, or bolts, that hold the tractional layer in place.

### SUMMARY

The present inventors have recognized, among other things, that a problem to be solved includes forming a composite member with a base polymer board with at least one additional layer, such as a tractional layer that promotes traction, where the tractional layer remains affixed to the polymer board through a variety of conditions, including environmental and temporal.

In one example, the present inventors have found solutions to these problems associated with a composite traction member and method of forming the composite traction member. The composite traction member includes a polymer board (substrate) having a tractional layer robustly coupled with the polymer board with a weld assembly.

In one example, the composite traction member, includes a polymer structural substrate (e.g., polymer board, plank, panel or the like) welded with a polymer traction layer (e.g., film, ribbon, strip, substrate or the like). For example, the composite traction member includes a polymer traction layer welded to the polymer structural substrate (e.g., polymer board, plank, panel or the like). In one example, the region or area where the polymer traction layer and the polymer substrate are interconnected (e.g., intersection, area, or region of adhesion) is a molded weld assembly.

For example, the polymer traction layer is a solid structure, optionally having flexibility or pliability. The polymer traction layer in some examples is a film, ribbon, strip, or substrate that is welded to the polymer structural substrate. In an example, the polymer traction layer includes a tractional face on one side and a layer interface on an opposing side for coupling with the polymer structural substrate. The composite traction member includes, for example, the polymer traction layer having a tractional face (that promotes a non-slip style surface) as an exposed portion of the polymer traction layer. In an example, the tractional face is textured (e.g., knurled or roughened) or adhesive, (e.g., having sticky or tacky characteristics) or a combination of textured and adhesive, thereby forming a surface that promotes traction (e.g., a “non-slip” surface).

In an example, the traction layer is manufactured before or in concert with manufacturing of the polymer structural substrate. For example, a molten traction layer polymer is extruded through at least two rollers as part of a cast extrusion method. The molten traction layer polymer, in some examples, is the same material as the structural substrate polymer, and in other examples is a different material from the structural substrate polymer.

In one instance, the molten traction polymer cools and sets as it passes through one or more rollers. In an example, one of the rollers imprints, embosses or otherwise forms a textured surface on the setting traction polymer. The textured surface forms the tractional surface on at least one side of the traction layer. The textured surface, in some examples, is an irregularly patterned surface that enhances traction, provides an aesthetic appearance (e.g., woodgrain) or the like. In other examples, the textured surface is a repeated pattern that enhances traction, provides an aesthetic appearance (e.g., herringbone, waves) or the like. In another example, the traction polymer is processed to provide an adhesive form of enhanced traction (e.g., sticky, tacky or similar). For instance, the traction polymer is extruded and pressed by rollers.

In an example another side of the traction layer is a second surface, for instance an opposing surface to the tractional surface. Optionally, the second surface, includes, but is not limited to, a textured surface, smooth surface or a combination of surface textures stamped, rolled or the like. In an example, the opposing side of the tractional layer to the traction surface, is the interface surface of the traction layer. The example final product is a solid traction layer with a tractional surface and an opposing interface surface.

In one example, the traction layer formed from cast extrusion, or a similar method, is subsequently installed (e.g., inserted, threaded, or placed) in a mold for coupling with the structural substrate by way of the molded weld assembly. For example, the mold is a component of either an extrusion (or pultrusion) molding system or an injection molding system or a hybrid of both extrusion (or pultrusion) molding and injection molding. For instance, the molten substrate polymer is installed into the mold with the tractional surface of the polymer traction layer facing toward at least one side of the mold facing the cavity. The interface surface of the traction layer is exposed to the molten substrate polymer. The molten polymer melts at least a portion of the interface surface at a molding induced fusion zone, thereby welding the interface surface with the molten substrate polymer. The molten substrate polymer and the melted portions of the interface surface of the traction layer are set (e.g., through cooling) thereby joining the interface surface of the traction layer to the substrate face of the structural substrate and interconnecting the two surfaces.

In an example of manufacturing the composite traction member, a solid polymer traction layer is installed (e.g., inserted, retained, placed, held) in the mold cavity. For instance, the polymer traction layer is installed statically or in a secured manner in the mold cavity with the tractional surface of the solid polymer traction layer in contact with one of the sides of the mold. For instance, the solid polymer traction layer is coupled along one or more of the sides or walls of the mold. Optionally, the solid polymer traction layer is a pliable layer that assumes the contour of the associated sides or walls of the mold. In other example, the solid polymer traction layer is coupled along a plate, contoured surface or the like downstream from an extrusion or pultrusion die (an example of a mold herein) to form the molded weld assembly.

In an example, the polymer traction layer is coupled along the polymer structural substrate. In one example, the polymer structural substrate includes a plurality of faces defining the perimeter of the polymer structural substrate and optionally surrounding a substrate core. The substrate core is, for example, a foamed polymer material that forms a durable polymer structural substrate. At least one of the faces of the polymer structural substrate interconnect with the polymer traction layer. For example, the composite member includes the polymer structural substrate having a substrate face coupled with the layer interface of the polymer traction layer.

A molded weld assembly interconnects, such a robust interconnection, the polymer traction layer and the polymer structural substrate. The molded weld assembly interconnects the layer interface of the polymer traction layer with the substrate face of the polymer structural substrate. For example, the substrate face and the layer interface are continuously interconnected along a length of the composite traction member with the molded weld assembly. In another example, the polymer structural substrate and the polymer traction layer are immutably interconnected. In an example, the area where the layer interface interconnects with the substrate face is a molding initiated fusion zone.

The molding initiated fusion zone is an example of an area formed during manufacturing of the composite traction member. The molding initiated fusion zone includes, for example, a heat-initiated bond that initiates fusion between the substrate face and the layer interface with intermingling of the materials of both. The heat-initiated bond occurs during the molding process of the polymer structural substrate.

The method of molding the polymer structural substrate includes forming the polymer structural substrate within a mold. The mold has a plurality of sides surrounding a mold cavity. In an example, the mold cavity has a port at or proximate to a proximal or distal end of the mold cavity. The port provides an introduction opening that allows the introduction of a molten polymer (e.g., inserted, injected, extruded) to the mold cavity. In the present application molding includes molding processes, such as injection molding or the like, as well as extrusion or pultrusion processes wherein the mold cavity includes a zone downstream of the extrusion or pultrusion die.

In an example, after installation of the polymer traction layer along the mold, a molten polymer is introduced into the mold through the port. The molten polymer melts at least a portion of the interface surface of the polymer traction layer melts. Melting the interface surface begins fusion of the polymer traction layer and the polymer structural substrate and formation of the molded weld assembly.

The molten polymer applied along the polymer traction layer begins to cool after molding (e.g., injection molding, extrusion, pultrusion or the like). Cooling sets and forms the polymer structural substrate, and accordingly sets the molded weld assembly fusion zone between the substrate and the traction layer. In an example, the heat of the molten substrate polymer melts at least a portion of the interface surface of the polymer traction layer and welds the molten substrate polymer with the interface surface forming a molded weld assembly. In an example, the molten polymer substrate cools with the melted portion of the interface surface. Setting of the molten substrate polymer and the interface surface, for example, welds the substrate face of the polymer structural substrate with the interface surface, thereby interconnecting (e.g., fusing, intermingling or the like) the two surfaces. The set interface surface and substrate face form a welded bond between the polymer traction surface and the polymer structural substrate. In an example, the substrate polymer and the interface surface of the polymer traction layer are interconnected with the molded weld assembly area.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1A is an example of a composite traction board according to at least one embodiment of the present application.

FIG. 1B is an example of a top view of a composite traction board according to at least one embodiment of the present application.

FIG. 2A is an example of a composite traction board according to at least one embodiment of the present application.

FIG. 2B is an example of a top view of a composite traction board according to at least one embodiment of the present application.

FIG. 3A is an example of a close-up view of a molded weld assembly according to at least one embodiment of the present application.

FIG. 3B is an example of a close-up view of a molded weld assembly according to at least one embodiment of the present application.

FIG. 4A is an illustration of a step in a method of manufacturing a composite traction board according to at least one embodiment of the present application.

FIG. 4B is an illustration of a step in a method of manufacturing a composite traction board according to at least one embodiment of the present application.

FIG. 4C is an illustration of a step in a method of manufacturing a composite traction board according to at least one embodiment of the present application.

FIG. 4D is an illustration of a step in a method of manufacturing a composite traction board according to at least one embodiment of the present application.

FIG. 4E is an illustration of a step in a method of manufacturing a composite traction board according to at least one embodiment of the present application.

FIG. 4F is an illustration of a step in a method of manufacturing a composite traction board according to at least one embodiment of the present application.

FIG. 4G is an illustration of a step in a method of manufacturing a composite traction board according to at least one embodiment of the present application.

FIG. 4H is an illustration of a step in a method of manufacturing a composite traction board according to at least one embodiment of the present application.

### DETAILED DESCRIPTION

Boards, polymer boards or the like are subject to deformation, warping or the like over time. In some examples, polymer boards include surfaces that result in a slippery surface when exposed to environmental conditions such as moisture (e.g., dew, rain, snow, ice or the like). Optionally, to counter the occurrence of a slippery surface, traction-promoting layers are fastened, coupled with adhesives or, in some examples, are laminated to polymer boards. The traction-promoting layers are also susceptible to certain environmental conditions that cause decomposition, deformation or both in polymer boards and to any components coupled with the polymer boards. For example, moisture, temperature fluctuations, sunlight exposure or the like breaks down adhesives, the underlying polymer board, or the like. Additionally, in other examples, wear and tear of the polymer board including supplemental components, like traction-promoting layers, may accelerate deformation and decomposition between the boards and tractional layers. Deformation, decomposition or the like cause one or more of wrinkling, cracking, or bubbling of tractional layers that may decrease the lifespan of the tractional layer (e.g., function).

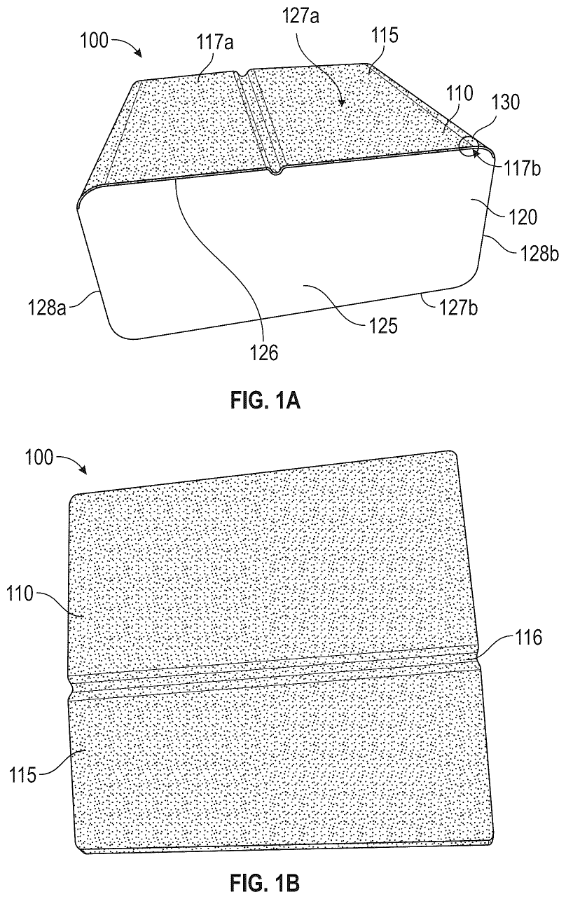

Referring to FIG. 1A, in one example, a composite traction member 100, includes a polymer structural substrate 120 (e.g., polymer board, plank, panel or the like) welded with a polymer traction layer 110 (e.g., film, ribbon, strip, substrate or the like). In an example, the polymer structural substrate 120 is an extruded or molded substrate (e.g., foundational component) with additional components coupled there along. The polymer structural substrate 120, for example, includes a substrate core 125 and one or more substrate faces 126. For instance, the one or more substrate faces 126 are the outer perimeter of the polymer structural substrate 120 and surround the substrate core 125. The one or more substrate faces 126 for example, include an upper substrate face 127a and an opposed lower substrate face 127b. In another example the one or more substrate faces 126 includes a first side surface 128a and a second side surface 128b. For instance, the first side surface 128a and second side surface 128b are angularly oriented (e.g., are sides or edges) relative to the upper substrate face 127a and the lower substrate face 127b, such as transversely oriented. In another example, the first side surface 128a and the second side surface 128b are obtusely or acutely angled relative to the upper substrate face 127a and the lower substrate face 127b.

Optionally, the upper substrate face 127a is a flat surface (e.g., level, at an angle less than 5 degrees, or less than 1 degree, having a minimal arcuate shape). In an example, the upper substrate face 127a is substantially parallel to the lower substrate face 127b (e.g., oriented within less than 1 degree relative to the opposing face). The first side surface 128a and the second side surface 128b are, for example, also oriented parallel to each other (e.g., within less than 1 degree relative to the opposing face).

In an example, the polymer structural substrate 120 is formed within a mold or is extruded into a form that includes one or more of the upper substrate face 127a, lower substrate face 127b, the first side surface 128a or the second side surface 128b as described previously. For example, a molten polymer is applied to a mold having the desired form or is extruded into the desired form. The molten polymer, when set or cooled includes the upper substrate face 127a, the lower substrate face 127b, the first side surface 128a and the second side surface 128b that surrounds the substrate core 125.

The substrate core 125, for example, is a solid substrate, support structure, or base substrate of the polymer structural substrate 120. The structural substrate is formed from polymer such as a polyethylene (PE), or other polyolefin resin. In some examples, the polymer structural substrate 120 is either a thermoplastic or a thermoset. In some examples, the structural substrate is impregnated, embedded, incorporates, or otherwise includes additives, such as filaments, fiberglass, or the like. In other examples, other additives are included to decrease the weight of the structural substrate or provide other properties (e.g., ultraviolet resistance, color, wear resistance, or the like). In other examples, the substrate core 125 includes a polymer such as a polyvinyl chloride (PVC), high-density polyethylene (HDPE), acrylonitrile butadiene styrene (ABS), or polypropylene (PP). The type of polymer selected for the substrate core 125 is determined by the specified use. In an example, the substrate core 125 is a solid structure, when set or cooled. In another example, the substrate core 125 is a foamed polymer that includes one or more gaps, cavities, reticulations (open or closed), recesses or the like.

Polymers, or plastics, are generally divided into two categories, thermosets and thermoplastics. A thermoset is a plastic in which a chemical reaction sets the molecular bonds after first forming the plastic, and then the bonds cannot be broken again without degrading the plastic. Thermosets are difficult to melt; therefore, once a thermoset is set it is difficult to weld. Examples of thermosets include epoxies, silicone, vulcanized rubber, polyester, and polyurethane.

Thermoplastics, by contrast, form long molecular chains, which are often coiled or intertwined, forming an amorphous structure with decreased long-range, crystalline order (e.g., relative to a thermoset, alloy or the like). Some thermoplastics are fully amorphous, while others have a partially crystalline or partially amorphous structure. Both amorphous and semicrystalline thermoplastics have a glass transition temperature, above which welding, for example occurs. Semicrystalline thermoplastics also have a specific melting temperature above the glass transition temperature. Above this melting temperature, the viscous liquid is a free-flowing liquid.

Welding is a fabrication process that joins materials, usually metals or thermoplastics, by using high heat to melt the parts together causing fusion between the surfaces. Fusion, in an example, is an interconnection of two surfaces, for instance by welding, chemical reaction or the like.

Referring again to FIG. 1A, in an example, the composite traction member 100 includes a polymer traction layer 110 welded to the polymer structural substrate 120. The polymer traction layer 110 is formed from a polymer material such as a polyethylene, or other polyolefin resin. In some examples the polymer traction layer 110 is either thermoplastic or a thermoset. For example, the polymer traction layer 110 is a solid structure, optionally having flexibility or pliability, such as a film, ribbon, strip or substrate. The polymer traction layer 110 is welded to the polymer structural substrate 120.

The polymer traction layer 110, for example, is a layer that is oriented to be the upper layer of the composite traction member 100. The polymer traction layer 110 has an outwardly facing surface 117a that is also described as the tractional face 115. The tractional face 115 is textured (e.g., contoured, profiled, or the like) or otherwise formed to promote traction with the composite traction member 100. In an example, the polymer traction layer 110 includes the tractional face 115 on one side and a layer interface 117b on an opposing side for coupling with the polymer structural substrate 120.

As illustrated in FIG. 1B, the polymer traction layer 110 includes the tractional face 115 (providing a decreased-slip surface, also referred to as non-slip) as an exposed portion of the polymer traction layer 110. In an example, the tractional face 115 is textured (e.g., knurled, roughened, contoured, profiled) or adhesive (e.g., having sticky or tacky characteristics), or a combination of textured and adhesive, thereby forming a surface that promotes traction. For instance, the tractional face 115 has a texture formed to simulate or replicate a roughened surface, such as a concrete or cement surface, pavers, rock, crenelated, corrugated, or the like. In another example, the tractional face 115 includes a replication of a lumber profile or other material that is foundational and textured (e.g., concrete, brick, rock, or the like). In some examples, forming the texture of the tractional face 115 includes forming a surface having a roughened, knurled, contoured character, or the like from a polymer material that visually appears to be another type of surface material (e.g., concrete, brick, rock, or the like). In other examples, the tractional face 115 is knurled, roughened, contoured or the like without simulating or replicating a natural material, like stone, brick, or wood. Optionally, one or more aesthetic features 116, such as one or more grooves as illustrated in FIG. 1B, are added to the polymer traction layer 110 or tractional face 115. For instance, the tractional face 115 includes a graphic that does not extend, or partially extends through the layer. In another example, aesthetic features include, but are not limited to, grooves, channels, ridges, knurling, relieved features, studs, embossing, imprinting (images, text), printing (images, text), or the like that extend through (e.g., approximately between 75 percent and approximately 99 percent indented into the traction layer, or the like) the polymer traction layer 110.

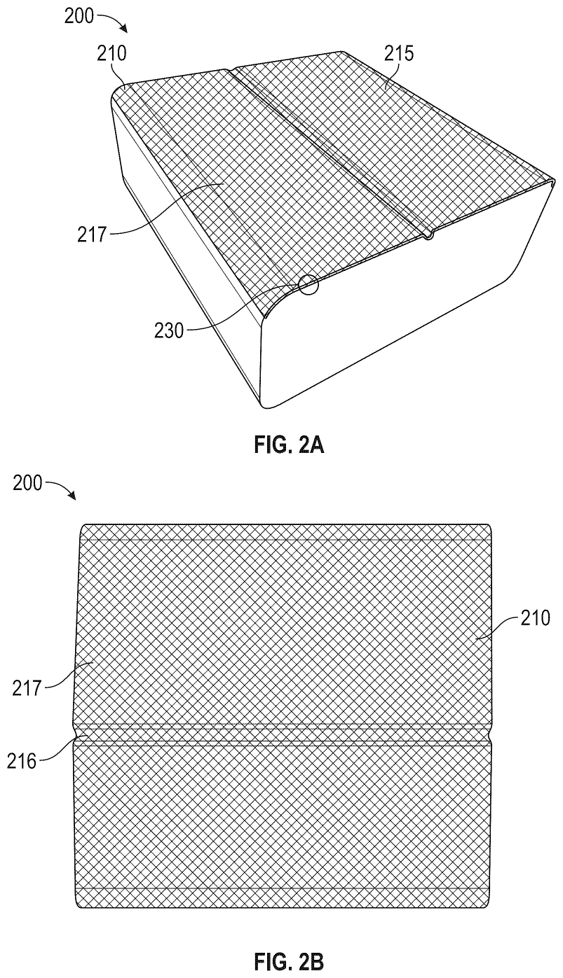

Another example of a composite traction member 200 is illustrated in FIGS. 2A and 2B. The composite traction member 200 includes a tractional face 215. The tractional face 215 is, for example, an exterior surface of a polymer traction layer 210 (i.e., a film, membrane, sheet, ribbon or the like) having, an adhesive characteristic (e.g., tacky or sticky). In this example, the adhesive characteristic is provided with a tacky surface 217 having decreased surface roughness in comparison to the profiled tractional face 115 shown in FIG. 1A. Similar to the polymer traction layer 110 shown in FIGS. 1A and 1B, the polymer traction layer 210 of FIGS. 2A and 2B includes a polymer such as an elastomer. For example, the polymer traction layer 210 is a flexible or pliable structure before interconnection or joining with the polymer structural substrate 120. For example, the polymer traction layer 210 is applied as a sheet to the polymer structural substrate 120. Similar to FIG. 1B, FIG. 2B is a top view of the polymer traction layer 210 that includes one or more aesthetic features 216 including but not limited to, grooves, channels, ridges, knurling, relieved features, studs, embossing, imprinting (images, text), printing (images, text), or the like or the like.

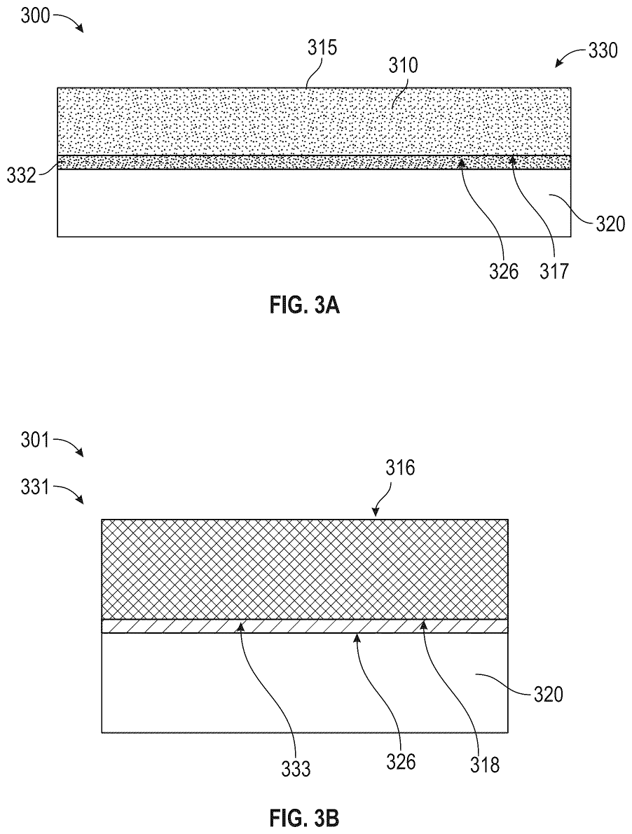

Illustrated in FIG. 3A, is a close-up view of the composite traction member 100 at the region 130 that includes the polymer traction layer 310 coupled to the polymer structural substrate 320 (e.g., polymer board, plank, panel or the like). For example, the polymer traction layer 310 extends along the polymer structural substrate 320. In an example, the polymer traction layer 310 is welded with the polymer structural substrate 320. Welding the polymer traction layer 310 with the polymer structural substrate 320 forms a strong bond between the polymer traction layer 310 and the polymer structural substrate 320.

The polymer traction layer 310 welded to the polymer structural substrate 320 includes in one example, an interconnection (e.g., intersection, joining, bonding, adhesion region, or the like) area between the polymer traction layer 310 and the polymer structural substrate 320. In an example, the polymer traction layer 310 welded with the polymer structural substrate 320 is an example of a molded weld assembly 330. The molded weld assembly 330 interconnects, such as a robust interconnection, a layer interface 317 of the polymer traction layer 310 and a substrate face 326 the polymer structural substrate 320. A robust interconnection includes, for example, a connection between the layer interface 317 and the substrate face that decreases wrinkling, peeling, flaking or otherwise separating. For example, with a substrate face 326 of the polymer structural substrate 320 is interconnected with the layer interface. For example, the layer interface 317 is an opposing side of the polymer traction layer 310 from the tractional surface 315. The substrate face 326 is a surface of the polymer structural substrate 320 that faces the polymer traction layer 310 of a composite traction member 300. For example, the substrate face 326 and the layer interface 317 are continuously interconnected along a length (including the associated areas) of the composite traction member 300 with the molded weld assembly 330. In another example, the polymer structural substrate 320 and the polymer traction layer 310 are immutably interconnected. For instance, immutably interconnected includes a weld between the polymer traction layer 310 and the polymer structural substrate 320 that causes damage to one of the polymer traction layer 310 or the polymer structural substrate 320. In another instance, a tool or chemical agent is used to separate the polymer traction layer 310 from the polymer structural substrate 320.

In an example, the area where the layer interface 317 interconnects with the substrate face 326 is a molding initiated fusion zone 332. The molding initiated fusion zone 332 is an example of an area formed during manufacturing of the composite traction member 100. The molding initiated fusion zone 332 includes, for example, a heat-initiated bond that causes fusion between the substrate face 326 and the layer interface 317 by interconnecting (e.g., fusing, intermingling or the like) of the materials of both.

Illustrated in FIG. 3B is a close-up view of a molded weld assembly 331 taken at area 230 (illustrated in 2B). For instance, another type of composite traction member 301 including a tacky tractional surface 316 (e.g., sticky) having a molded weld assembly 331. Opposing the tacky tractional surface 316 is a layer interface 318. The tacky tractional surface 316 with the layer interface 318 is a sheet (e.g., membrane, ribbon, or the like) welded to the substrate face 326 in an example. The molded weld assembly 331 is similar in at least some regards to the molded weld assembly 330 shown in FIG. 3A. For example, the molded weld assembly 331 immutably interconnects the layer interface 318 with the substrate face 326 continuously extended along the length of the polymer structural substrate 320. In an example, the area where the layer interface 318 interconnects with the substrate face 326 is a molding initiated fusion zone 333. The molding initiated fusion zone 333, for example extends along the surface of the polymer structural substrate 320 to interconnect the layer interface 318 with the substrate face 326. The interconnection is a surface-to-surface interconnection with the two surfaces becoming at least partially interconnected at the area where the layer interface 318 and the substrate face 326 meet during manufacture.

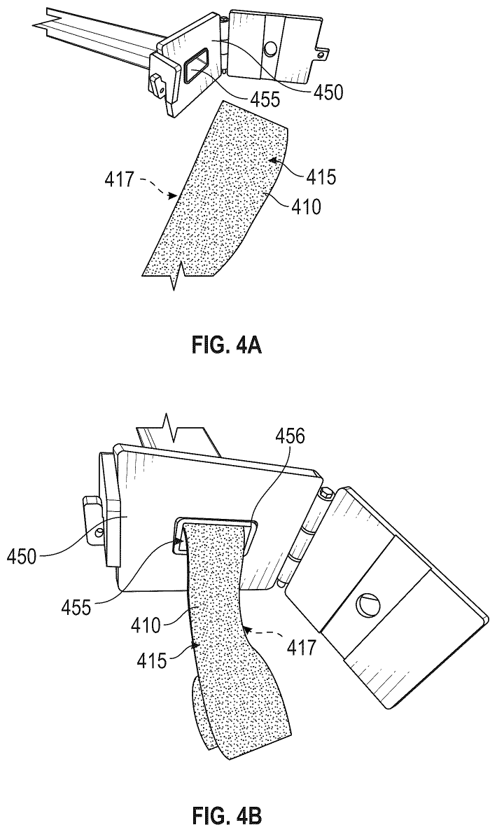

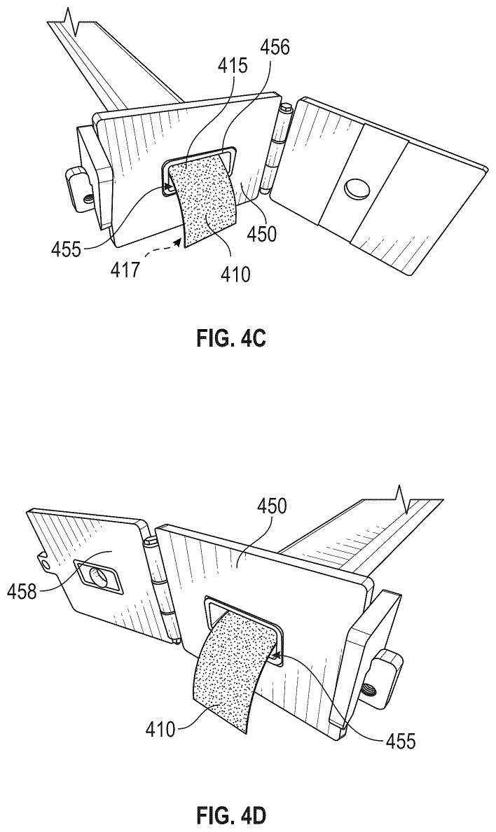

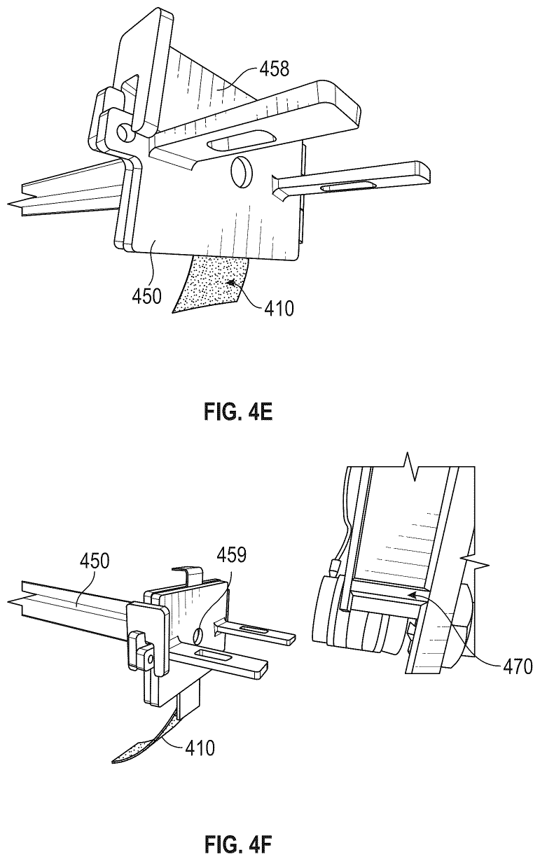

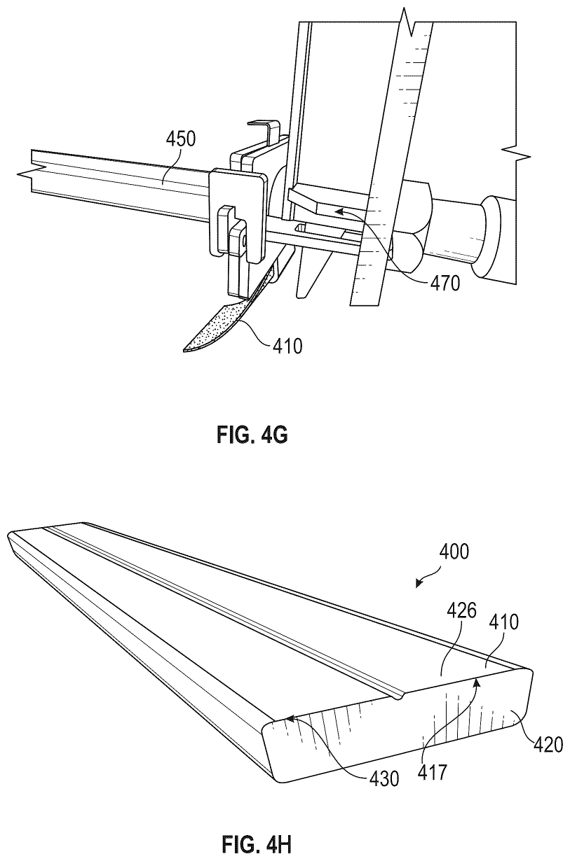

Illustrated in FIGS. 4A-4H are examples of manufacturing steps for forming a composite traction member 400 (illustrated in FIG. 4H). The method includes, for example, positioning a polymer traction layer 410 within a mold 450, as illustrated in FIG. 4A. The polymer traction layer 410 is in the form of, for instance one or more of a film, ribbon, strip, sheet, substrate or the like (e.g., a solid) formed from a polymer, elastomer, or the like.

Optionally, the polymer traction layer 410 is formed separately from, such as before, the remaining components of the composite traction member 400 that are discussed below. For instance, the polymer traction layer 410 is manufactured before or in concert with manufacturing of the polymer structural substrate 420 (illustrated in a final form in FIG. 4H). For example, the polymer traction layer 410 is formed from a molten polymer. The molten polymer, in some examples, is the same material as the polymer used for the polymer structural substrate (as will be described further below). In other examples, the polymer is a different material from the polymer used for the structural substrate polymer (the process for forming the polymer structural substrate will be discussed further, below).

The molten polymer is, for example, extruded through a die and optionally two or more rollers as part of a cast extrusion method. In one instance, the molten polymer cools and sets as it passes through the one or more rollers. In an example, polymer traction layer 410 is a set polymer (e.g., completely set, 99 percent set, 95 percent set, 90 percent set, remains pliable or otherwise set so it remains intact when bonded with the polymer structural substrate 420 and in the desired form). In an example, one of the rollers forms the tractional face 415 by applying a texture such as imprinting, embossing or otherwise forming a texture on the setting polymer traction layer. For instance, the tractional face 415 includes a textured surface on one side and a layer interface 417 on the other for bonding with the polymer structural substrate 420. The textured surface, as the tractional face 415, in some examples, is an irregularly patterned surface that enhances traction, provides an aesthetic appearance (e.g., woodgrain, stone, brick) or the like. In other examples, the textured surface is a repeated pattern that enhances traction, provides an aesthetic appearance (e.g., herringbone, waves, checkered) or the like.

In another example, the tractional face 415 is a tacky surface (as described previously) or otherwise formed to provide traction characteristics to the finished product. For example, the tractional face 415 is manufactured to include a tacky surface (e.g., sticky) that enhances the traction of the tractional face 415. Optionally, the tractional face 415 includes both a tacky surface and a textured surface.

In an example, the opposing side of the polymer traction layer 410 from the tractional face 415 is a layer interface 417. Optionally, the surface that forms the layer interface 417, includes, but is not limited to, a textured surface, smooth surface or a combination of surface textures stamped, rolled or the like.

The polymer traction layer 410 is positioned within a mold cavity 455 as indicated in FIGS. 4B and 4C. The mold cavity 455 is enclosed by one or more walls 456 of a mold that surrounds the mold cavity 455. The polymer traction layer 410 is positioned (e.g., inserted, fed, threaded, placed, introduced or the like) within the mold cavity 455. For instance, the polymer traction layer 410 is positioned with the tractional face 415 in contact (e.g., touching one or more walls, partially touching one or more walls, minimally separated, such as less than a millimeter, from the one or more walls), abutting or placed relative to one of the one or more walls 456. In an example, the tractional face 415 is in continuous contact with at least one wall of the mold cavity 455, for instance surface to surface contact along the wall. For example, the tractional face 415 is positioned relative to one of the one or more walls 456 of the mold cavity 455 to be the uppermost surface of the final product. The polymer traction layer 410 is positioned (e.g., installed, introduced, inserted), for example, in the mold cavity 455 with the layer interface 417 disposed within the mold cavity 455 facing an initially empty portion, or recess, of the mold cavity 455.

For instance, the polymer traction layer 410 is coupled along one or more of the sides or walls of the mold 450. Optionally, the polymer traction layer 410 is a pliable layer that assumes the contour of the associated sides or walls of the mold 450. In another example, the polymer traction layer 410 is coupled along a plate, contoured surface, or the like of the mold. Optionally, the polymer traction layer 410 extends at least partially along the longitudinal length of the mold cavity 455.

Referring now to FIGS. 4D and 4E, in an example of manufacturing the composite traction member 400, the polymer traction layer 410 is retained (e.g., held, supported, or the like) in the mold cavity 455 statically or in a secured manner with the tractional face 415 in contact with one or more of the surfaces of the mold. For example, the polymer traction layer 410 is pulled taught along the mold 450 within the mold cavity 455. The mold cavity 455 includes a door 458 (e.g., cover, door, clamp or the like) that is closed to retain (secure, anchor, hold, or the like) the polymer traction layer 410 within the mold cavity 455.

The polymer traction layer 410 is optionally inserted through the mold 450 and the mold cavity 455 with the polymer traction layer 410 secured (e.g., anchored, clamped or the like) with the door 458 shown in FIG. 4D (open) and FIG. 4E (closed). The door 458 serves as a clamp that holds the polymer traction layer 410 in place. Optionally, a portion of the polymer traction layer 410 remains outside of the mold 450 after the door 458 is closed and retains the polymer traction layer 410, as illustrated in FIG. 4E. In another example, the polymer traction layer 410 is inside the mold cavity 455 and is retained with an internal retention feature such as a brace, clamp, fastener or the like present within the mold including part of a mold wall.

In an example, the polymer traction layer 410 is retained within the mold 450 with the tractional face 415 directed toward one or more of the mold walls to isolate the tractional face 415 from application of molten polymer to form the polymer structural substrate (see above FIGS. 4F and 4G). In one example, the polymer traction layer 410 is installed (e.g., inserted, threaded, or placed) in the mold 450 while maintaining a space within the mold cavity 455 for receiving a molten polymer.

The mold 450 is, for example, a component of either an extrusion (or pultrusion) molding system or an injection molding system or a hybrid of both extrusion (or pultrusion) molding and injection molding. As illustrated in FIGS. 4F and 4G, the mold 450 is, for example, brought in contact with an extruder 470. The extruder 470, for instance, dispenses molten polymer for the polymer structural substrate into a port 459, also referred to as a die for extrusion or pultrusion. In an example, the port 459 of the mold 450 is positioned proximate to a proximal or distal end of the mold cavity 455. The port 459 is, for example, an opening that allows the introduction (e.g., inserted, injected, extruded) of a molten polymer to the mold cavity 455.

In an example, the mold 450 is coupled with the extruder 470 with the polymer traction layer 410 retained. The extruder 470 supplies the molten polymer, that will form the polymer structural substrate 420 (as illustrated in FIG. 4H), into the mold 450. In an example, the molten polymer includes one or more of a base polymer, filaments or other materials included for specified properties (e.g., elastomeric qualities, UV resistance, wear resistance, warp resistance, or the like). In examples, the molten polymer is formed from pellets or flakes of polymer. The pellets or flakes are optionally new (virgin) pellets or flakes, or the polymer pellets are formed from recycled plastic. The polymer pellets or flakes are heated and accordingly melted form the molten polymer for molding (e.g., extrusion, pultrusion, injection molding or the like).

During extrusion molten polymer is fed from a hopper into a barrel of the extruder 470. For instance, the material is heated and melted by heat and mechanical energy provided with heaters and screws proximate to the barrel. During extrusion, the molten polymer delivered through extrusion profile provided by a die forming a substrate that is, optionally stretched, and cooled to set. The molten polymer flows along and welds (as discussed related to FIGS. 3A and 3B) with the previously installed polymer traction layer at the interface surface. In an example, the polymer structural substrate, once set, is a linear product that is cut to a desired length (as previously discussed in relation to FIGS. 1A, 1B, 2A, and 2B).

In another example, the composite traction member 400, shown in FIGS. 1A, 1B, 2A and 2B, is formed with an injection molding process. In the injection molding process, a molten polymer is supplied to fill the mold 450. The molten polymer, similar to the extrusion method described above, melts the interface surface (such as layer interface 317, 318). The molten polymer is cooled in the mold to set the polymer structural substrate (such as polymer structural substrate 320, 420) to the mold shape. The cooled and set polymer is, for example, removed as a composite traction member 400 having the polymer traction layer 410 welded along the substrate.

The method of molding the polymer structural substrate, optionally includes forming the polymer structural substrate (discussed previously related to FIGS. 1A, 1B, 2A and 2B) within the mold 450. As described above, as the molten polymer is supplied to the mold cavity 455, the molten polymer melts at least a portion of the layer interface 417 of the polymer traction layer 410 at a molding induced fusion zone (such as molding initiated fusion zone 332 discussed related to FIGS. 3A and 3B). The intermingling of molten polymer forming the substrate and the layer interface 417 at the molding induced fusion zone (such as 332) welds the layer interface 417 with the molten substrate polymer (as described related to FIGS. 3A and 3B. For instance, the molten polymer and at least partially molten polymer traction layer 410 welds the polymer traction layer 410 with the molten polymer of the polymer structural substrate. A molded weld assembly (see FIGS. 3A, B) includes the molding induced fusion zone (such as 332) with the layer interface 417 fused with the with the molten polymer.

The molten polymer and the melted portions of the layer interface 417 are set (e.g., through one or more of active or passive cooling) thereby fixing the interface surface of the polymer traction layer to the substrate face of the structural substrate and interconnecting the two surfaces. For instance, as the molten polymer supplied (e.g., through injection molding, extrusion, pultrusion or the like) in the mold 450 and welded along the polymer traction layer 410, such as along the layer interface 417, begins to cool, or set, the cooled or set molten polymer forms the polymer structural substrate 420. In an example, the cooled or set polymer as the polymer structural substrate 420, sets the molded weld assembly between the polymer structural substrate 420 and the polymer traction layer 410. Setting the molten polymer substrate and intermingled with the layer interface 417, for example, completes the weld of a substrate face 426 of the polymer structural substrate 420 with the layer interface 417 of the polymer traction layer 410 and provides a robust interconnection (e.g., fused, intermingled, or the like) therebetween.

FIG. 4H shows an example of the molded weld assembly 430 (now set) of the polymer structural substrate 420 fused to the layer interface 417 of the polymer traction layer 410. The polymer structural substrate 420 is interconnected with the layer interface 417 with a bond that integrates the polymer structural substrate 420 with the polymer traction layer 410 molded weld assembly 430. The molded weld assembly 430, in an example, provides a continuous interconnection between the polymer traction layer 410 and the polymer structural substrate 420 including, but not limited to, a continuous surface to surface interconnection (e.g., entirely continuous, partially continuous with one or more breaks or the like).

### Various Notes and Aspects

Aspect 1 can include subject matter such as a composite traction member comprising, a polymer traction layer including a tractional face configured to promote traction and a layer interface; a polymer structural substrate molded to the polymer traction layer, the polymer structural substrate including a substrate core and a substrate face coupled along the layer interface; and a molded weld assembly interconnecting the polymer structural substrate and the polymer traction layer, the molded weld assembly including the substrate face and the layer interface and a molding initiated fusion zone.

Aspect 2 can include, or can optionally be combined with the subject matter of Aspect 1, to optionally include the tractional face is a textured surface.

Aspect 3 can include, or can optionally be combined with the subject matter of one or any combination of Aspects 1 or 2 to optionally include the tractional face is a tacky surface.

Aspect 4 can include, or can optionally be combined with the subject matter of one or any combination of Aspects 1-3 to optionally include the molding initiated fusion zone includes a heat-initiated bond of the substrate face with the layer interface.

Aspect 5 can include, or can optionally be combined with the subject matter of one or any combination of Aspects 1-4 to optionally include the molded weld assembly includes the polymer structural substrate and the polymer traction layer immutably interconnected.

Aspect 6 can include, or can optionally be combined with the subject matter of one or any combination of Aspects 1-5 to optionally include the substrate face and the layer interface are continuously interconnected along a length of the composite traction member with the molded weld assembly.

Aspect 7 can include, or can optionally be combined with the subject matter of one or any combination of Aspects 1-6 to optionally include the polymer structural substrate is one of a board or panel.

Aspect 8 can include, or can optionally be combined with the subject matter of one or any combination of Aspects 1-7 to optionally include the molding initiated fusion zone is a weld between the substrate face and the layer interface where the polymer structural substrate is a solid polymer transitioned from a molten polymer, and the molten to solid transition fuses the substrate face with the layer interface.

Aspect 9 can include, or can optionally be combined with the subject matter of one or any combination of Aspects 1-8 to optionally include the polymer traction layer is a film.

Aspect 10 can include, or can optionally be combined with the subject matter of one or any combination of Aspects 1-9 to optionally include the polymer traction layer includes a thermoplastic.

Aspect 11 can include, or can optionally be combined with the subject matter of one or any combination of Aspects 1-10 to optionally include the polymer traction layer includes a thermoset.

Aspect 12 can include, or can optionally be combined with the subject matter of one or any combination of Aspects 1-11 to optionally include the polymer structural substrate includes a thermoplastic.

Aspect 13 can include, or can optionally be combined with the subject matter of one or any combination of Aspects 1-12 to optionally include the polymer structural substrate includes a thermoset.

Aspect 14 can include, or can optionally be combined with the subject matter of one or any combination of Aspects 1-13 to optionally include at least one of the polymer structural substrate or the polymer traction layer includes an elastomer.

Aspect 15 can include subject matter such as a method of forming a composite traction member, including: positioning a solid polymer traction layer in a mold, the solid polymer traction layer includes a tractional surface and an interface surface opposing the tractional surface, and the mold includes: one or more walls surrounding a mold cavity, the solid polymer traction layer positioned along at least one wall of the one or more walls and one or more mold ports at one or more of distal or proximal ends of the mold cavity; retaining the solid polymer traction layer in the mold cavity; introducing a molten substrate polymer into the mold through the one or more mold ports; welding the molten substrate polymer with the interface surface of the solid polymer traction forming a molded weld assembly, welding includes: melting at least a portion of the interface surface at a molding induced fusion zone and cooling the molten substrate polymer forming a structural substrate.

Aspect 16 can include, or can optionally be combined with the subject matter of Aspect 15, to optionally include the molded weld assembly includes a substrate face facing the interface surface on the structural substrate, the interface surface, and the molding induced fusion zone.

Aspect 17 can include, or can optionally be combined with the subject matter of one or any combination of Aspects 15 or 16 to optionally include with the tractional surface in contact with at least one side of the mold.

Aspect 18 can include, or can optionally be combined with the subject matter of one or any combination of Aspects 15-17 to optionally include introducing molding polymer includes at least one of extrusion molding or injection molding.

Aspect 19 can include, or can optionally be combined with the subject matter of one or any combination of Aspects 15-18 to optionally include the solid polymer traction layer is a film.

Aspect 20 can include, or can optionally be combined with the subject matter of one or any combination of Aspects 15-19 to optionally include the solid polymer traction layer is a pliable substrate.

Aspect 21 can include, or can optionally be combined with the subject matter of one or any combination of Aspects 15-20 to optionally include the solid polymer traction layer is one of a thermoplastic or thermoset.

Aspect 22 can include, or can optionally be combined with the subject matter of one or any combination of Aspects 15-21 to optionally include a recycled pelletized or recycled flake polymer is heated to form the molten substrate polymer.

Aspect 23 can include subject matter such as a method of forming a composite traction member, including: forming a solid polymer traction layer by cast extrusion, including: forming a tractional surface on one side of the solid polymer traction layer and forming an interface surface on an opposing side of the solid polymer traction layer; installing the solid polymer traction layer in a mold cavity of a mold, the mold cavity having one or more walls surrounding the mold cavity, wherein the tractional surface abuts at least one of the one or more walls surrounding the mold cavity and the interface surface faces the cavity in the mold; retaining the solid polymer traction layer within the cavity, introducing a molten substrate polymer into the mold, melting at least a portion of the interface surface at a molding induced fusion zone when the molten substrate polymer is inserted into the mold, and setting the molten substrate polymer forming a solid structural substrate; wherein a face of the set the molten substrate polymer is interconnected with the interface surface.

Aspect 24 can include, or can optionally be combined with the subject matter of Aspect 23, to optionally include the tractional surface is at least one of a textured surface or an adhesive surface.

Aspect 25 can include, or can optionally be combined with the subject matter of one or any combination of Aspects 23 or 24 to optionally include forming a molded weld assembly including a set interface surface on the traction layer; a set substrate face on the solid structural substrate; and a molded induced fusion zone inclusive of the interconnecting of the interface surface and the solid structural substrate.

Aspect 26 can include, or can optionally be combined with the subject matter of one or any combination of Aspects 23-25 to optionally include the set interface surface is continuously welded to the set substrate face.

Aspect 27 can include, or can optionally be combined with the subject matter of one or any combination of Aspects 23-26 to optionally include the molten substrate polymer is introduced with at least one of extrusion molding or injection molding.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel,” “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

Method aspects or examples described herein can be machine or computer-implemented at least in part. Some aspects or examples can include a computer-readable medium or machine-readable medium encoded with instructions operable to configure an electronic device to perform methods as described in the above aspects or examples. An implementation of such methods can include code, such as microcode, assembly language code, a higher-level language code, or the like. Such code can include computer readable instructions for performing various methods. The code may form portions of computer program products. Further, in an aspect or example, the code can be tangibly stored on one or more volatile, non-transitory, or non-volatile tangible computer-readable media, such as during execution or at other times. Aspects or examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples, or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A composite traction member comprising:
a polymer traction layer including:
a tractional face configured to promote traction; and
a layer interface;
a polymer structural substrate molded to the polymer traction layer, the polymer structural substrate including:
a substrate core; and
a substrate face coupled along the layer interface; and
a molded weld assembly interconnecting the polymer structural substrate and the polymer traction layer, the molded weld assembly including:
the substrate face and the layer interface; and
a molding initiated fusion zone.

2. The composite traction member of claim 1, wherein the tractional face is a textured surface.

3. The composite traction member of claim 1, wherein the tractional face is a tacky surface.

4. The composite traction member of claim 1, wherein the molding initiated fusion zone includes a heat-initiated bond of the substrate face with the layer interface.

5. The composite traction member of claim 1, wherein the molded weld assembly includes the polymer structural substrate and the polymer traction layer immutably interconnected.

6. The composite traction member of claim 1, wherein the substrate face and the layer interface are continuously interconnected along a length of the composite traction member with the molded weld assembly.

7. The composite traction member of claim 1, wherein the polymer structural substrate is one of a board or panel.

8. The composite traction member of claim 1, wherein the molding initiated fusion zone is a weld between the substrate face and the layer interface;
wherein the polymer structural substrate is a solid polymer transitioned from a molten polymer, and the molten to solid transition fuses the substrate face with the layer interface.

9. The composite traction member of claim 1, wherein the polymer traction layer is a film.

10. The composite traction member of claim 1, wherein the polymer traction layer includes a thermoplastic.

11. The composite traction member of claim 1, wherein the polymer traction layer includes a thermoset.

12. The composite traction member of claim 1, wherein the polymer structural substrate includes a thermoplastic.

13. The composite traction member of claim 1, wherein the polymer structural substrate includes a thermoset.

14. The composite traction member of claim 1, wherein at least one of the polymer structural substrate or the polymer traction layer includes an elastomer.

15. A method of forming a composite traction member, the method including:
positioning a solid polymer traction layer in a mold, the solid polymer traction layer includes a tractional surface and an interface surface opposing the tractional surface, and the mold includes:
one or more walls surrounding a mold cavity, the solid polymer traction layer positioned along at least one wall of the one or more walls; and
one or more mold ports at one or more of distal or proximal ends of the mold cavity;
retaining the solid polymer traction layer in the mold cavity;
introducing a molten substrate polymer into the mold through the one or more mold ports;
welding the molten substrate polymer with the interface surface of the solid polymer traction forming a molded weld assembly, welding includes:
melting at least a portion of the interface surface at a molding induced fusion zone; and
cooling the molten substrate polymer forming a structural substrate.

16. The method of forming the composite traction member of claim 15, wherein the molded weld assembly includes:
a substrate face facing the interface surface on the structural substrate;
the interface surface; and
the molding induced fusion zone.

17. The method of forming the composite traction member of claim 15, further comprising:
the tractional surface in contact with at least one side of the mold.

18. The method of forming the composite traction member of claim 15, wherein introducing molding polymer includes at least one of extrusion molding or injection molding.

19. The method of forming the composite traction member of claim 15, wherein the solid polymer traction layer is a film.

20. The method of forming the composite traction member of claim 15, wherein the solid polymer traction layer is a pliable substrate.

21. The method of forming the composite traction member of claim 15, wherein the solid polymer traction layer is one of a thermoplastic or thermoset.

22. The method of forming the composite traction member of claim 15, further comprising:
a recycled pelletized or recycled flake polymer is heated to form the molten substrate polymer.

23. A method of forming a composite traction member, the method including:
forming a solid polymer traction layer by cast extrusion, including:
forming a tractional surface on one side of the solid polymer traction layer; and
forming an interface surface on an opposing side of the solid polymer traction layer;
installing the solid polymer traction layer in a mold cavity of a mold, the mold cavity having one or more walls surrounding the mold cavity;
wherein the tractional surface abuts at least one of the one or more walls surrounding the mold cavity and the interface surface faces the cavity in the mold;
retaining the solid polymer traction layer within the cavity;
introducing a molten substrate polymer into the mold;
melting at least a portion of the interface surface at a molding induced fusion zone when the molten substrate polymer is inserted into the mold; and
setting the molten substrate polymer forming a solid structural substrate;
wherein a face of the set the molten substrate polymer is interconnected with the interface surface.

24. The method of forming the composite traction member of claim 23, wherein the tractional surface is at least one of a textured surface or an adhesive surface.

25. The method of forming the composite traction member of claim 23, further including:
forming a molded weld assembly including:
a set interface surface on the traction layer;
a set substrate face on the solid structural substrate; and
a molded induced fusion zone inclusive of the interconnecting of the interface surface and the solid structural substrate.

26. The method of forming the composite traction member of claim 25 wherein the set interface surface is continuously welded to the set substrate face.

27. The method of forming the composite traction member of claim 23 wherein the molten substrate polymer is introduced with at least one of extrusion molding or injection molding.
